(19) United States
(12) Patent Application Publication
(10) Pub. No.: US 2010/0031741 A1
(43) Pub. Date: Feb. 11, 2010

(54) Vehicle Tire Pressure Measurement Unit

(75) Inventor: Rainer Achterholt, Landschlacht (CH)

Correspondence Address: FROST BROWN TODD, LLC, 2200 PNC CENTER, 201 E. FIFTH STREET, CINCINNATI, OH, 45202, US

(73) Assignee: Global Dynamix AG, St Moritz (CH)

(21) Appl. No.: 12/440,277

(22) PCT Filed: Sep. 10, 2007
(86) PCT No.: PCT/EP07/07878

§ 371 Date: Apr. 27, 2009

(30) Foreign Application Priority Data
Sep. 11, 2006 (DE) 10 2006 042 565.0

(51) Int. Cl. B60C 23/04

(52) U.S. Cl. 73/146.3

(57) ABSTRACT

The present invention concerns a vehicle tire pressure measurement unit 1 with a valve 5 and a fastening element 3 for arrangement of a tire pressure measurement device 7 on the valve 5, in which the fastening element 3 includes a first fastening area for snap connection with a second fastening area made in complementary fashion on the valve 5 in order to secure the fastening element 3 and valve 5 to each other.

### FIELD OF THE INVENTION

The present invention generally concerns the area of pressure measurement for vehicle tires.

### BACKGROUND OF THE INVENTION

To record tire pressures of a vehicle tire it is known to arrange a measurement device within the vehicle tire, for example, on the valve. It is also known to transmit data indicating the recorded tire pressures produced by such a measurement device wirelessly, for example, to a central vehicle control.

Drawbacks of known approaches include their total weight, which can lead to imbalance of the vehicle wheels. During arrangement on the valve this can also lead to tilting and/or rotation of the valve to untightness of the valve and therefore a pressure loss of the vehicle tire.

Known approaches also have complex and complicated designs that lead to time-consuming and costly manufacturing steps.

The present invention provides a simply designed, lighter and more cost-effective solution to record vehicle tire pressure.

### SUMMARY OF THE INVENTION

The present invention utilizes a vehicle tire pressure measurement unit, a fastening element, a valve, a combination of fastening element and a tire pressure measurement device, as well as a use of a tire pressure measurement device according to the claims herein.

The vehicle tire pressure and measurement unit according to the invention includes a valve and a fastening element, with which a tire pressure measurement device can be fastened to the valve.

It is proposed, in particular, that the fastening element have a first fastening area with which a snap connection can be produced with a second fastening area shaped complementary on the valve in order to secure the fastening element and the valve to each other. The fastening element includes a receptacle to arrange the tire pressure measurement device in the fastening element. The receptacle of the fastening element has an area that extends into the first fastening area.

### BRIEF DESCRIPTION OF THE FIGURES

With reference to the enclosed schematic drawings variants of the invention are further explained below as examples. In the drawings:

FIG. 1 shows a schematic sectional view of a variant of a vehicle tire pressure measurement unit according to the invention;

FIG. 2 shows a cross-sectional view of a variant of a valve according to the invention;

FIG. 3 shows a cross-sectional view of a variant of a fastening element according to the invention;

FIG. 4 shows a cross-sectional view of a variant of a tire pressure measurement device according to the invention; and

FIG. 5 shows a view of a variant of a fastening element according to the invention.

### DESCRIPTION OF PREFERRED EMBODIMENTS

General explanations concerning the invention initially follow before describing the proposed variants.

The embodiment of the receptacle with an area extending into the first fastening area permits a reduction in total size.

At least the area of the receptacle extending into the first fastening area can be designed as a fluid guide in order to supply the tire fluid with which the tire can be filled via the valve.

The valve can be an ordinary screw valve or snap-in valve.

The receptacle can be made from an elastic or solid material; it preferably includes elastic material, for example, plastic.

Production of the receptacle can occur, for example, as a recess during production or as a recess in the subsequent manufacturing step. The receptacle leads to an overall small design.

The receptacle of a fastening element can preferably be dimensioned so that the tire pressure measurement device can be fully accommodated in it. This means that the tire pressure measurement device does not increase the design overall.

This also means that during wheel rotation forces acting on the vehicle tire measurement unit and its connection to a rib from the weight of the tire pressure measurement device can be reduced in comparison with ordinary approaches.

The receptacle can be designed rotationally symmetric relative to a longitudinal axis of a fastening element, which during use or in the installed state can run essentially perpendicular to a fastening surface of a rim. In this way forces and/or moments that might cause “tilting” of the vehicle tire pressure measurement unit around its longitudinal axis can be avoided

In variants, the first fastening area can be snapped into the second fastening area. In other variants, the second fastening area can be snapped into the first fastening area. In all cases screw, solder, welding and rivet connections, etc. can be avoided.

In one embodiment, the receptacle of a fastening element can include at least one thermally deformable area. This can be deformed to secure the fastening element in the receptacle so that the receptacle is at least partially adapted to the shape of the tire pressure measurement device.

In particular, the thermally deformable area can be designed so that the tire pressure measurement device can be secured in shape-mated and/or force-fit fashion in the receptacle of a fastening element. The thermally deformable area can then be adapted to the shape of the enclosed area of the tire pressure measurement device. The thermally deformable area can be shaped so that it engages behind the tire pressure measurement device. Additional expedients to secure the tire pressure measurement device can be omitted, if desired.

The receptacle of the fastening element preferably includes at least one support area, for example, with at least one stop element or annular stop for positioning of the tire pressure measurement device during assembly and in operation. The support area reaches a stipulated positioning within the receptacle in order to prevent any malfunctions of the tire pressure measurement devices because of imprecise and/or shifted arrangement.

Several stop elements spaced from each other and/or annular stops can be used, which cooperate with different areas of the tire pressure measurement device.

An embodiment according to the last two aspects permits simple combination possibility of the entire vehicle tire pressure measurement unit. Both connection possibilities offer secure holding for the snap correction.

In the first case the first fastening area can have at least one at least partially elastic area for the snap connection.

On the at least one at least partially elastic area of the first fastening area, at least one elastically deformable segment, tab or retainer can be formed.

Two, three, four, etc. segments, grooves and/or retainers can be used. Four retainer segments each with a cross section in the shape of a quarter circle viewed in the longitudinal direction are preferred.

The first fastening area can extend away from a support surface that can define a stop for the second fastening area.

For variants in which the second fastening area can engage in the first fastening area, the first fastening area can include a receptacle to accommodate the second fastening area. The receptacle can be produced, for example, as a notch during manufacture or added subsequently as a recess.

The first fastening area can include at least one guide surface, which borders the receptacle and/or can produce or at least support movements to it and/or into it. The guide surface is especially provided in order to guide the second fastening area when a connection to the first fastening area is produced. The guide surface can be made conical.

The receptacle of the first fastening area can include one or more recesses, retainers or grooves for the snap connection.

The fastening element can have at least one fluid passage opening. This can be formed in the first fastening area. The at least one fluid passage opening can be arranged in an area of the fastening element provided for arrangement of the tire pressure measurement device. One, two, three, four, . . . etc., fluid passage openings can be present. Their diameter can lie between 0.1 mm and 2 mm.

The fluid passages preferably are in fluid connection with the area of the receptacle provided as fluid guide. Because of this fluid for filling of a tire, which can be supplied via the valve, can be fed through the fluid guide of the receptacle and from there through the fluid passages to the tire.

The fluid passage openings can be arranged irregularly or regularly.

The valve can have a main body.

The main body of the valve is preferably made from a solid material, for example, plastic, metal, like brass, and a mixture of these materials.

The main body can be enclosed (at least) partially by a shell of elastic material. The shell can serve for snapping the valve into a vehicle rim. For this purpose the shell can have a groove in which an edge of a valve hole of the vehicle rim can be snapped. As an alternative the groove can be formed on the main body, in which the shell can be omitted.

For variants in which the first fastening area engages in the second fastening area, the second fastening area can include at least one receptacle to accommodate the first fastening area. This receptacle can be made as a notch during manufacture or added on as a recess.

The second fastening area can include at least one guide surface, which borders the receptacle and can cause or at least support movements to it and/or into it. The guide surface is provided in particular in order to guide the first fastening area when a connection is produced to the second fastening area.

In variants of which the second fastening area engages in the first fastening area, the second fastening area can include at least one at least partially elastic area for the snap connection. This area can have at least one elastic segment, tab or retainer.

It is also prescribed that the tire pressure measurement device is arranged on the valve by means of the fastening element.

The tire pressure measurement device can have a power supply and a pressure sensor. The power supply can be connected via a solder connection

The power supply can be connected via at least one force-fit and/or shape-mated contact which is produced by the fastening element.

The power supply can serve as a base for the tire pressure measurement device and stabilizer. Additional expedients, like supports, mounts, etc. can be avoided on this account.

The power supply can be arranged so that it serves as a cover for the tire pressure measurement device. Areas of the power supply can serve as cover, closure or the like for the open end of the receptacle of the fastening element away from the valve. Because of this essentially fluid-tight closure of the receptacle of the fastening element can preferably be achieved on the side that extends into a tire during use.

The area of the power supply serving as cover can be arranged as an alternative so that it lies between the area of the receptacle of the fastening element, which is provided as fluid guide for fluid (for example, compressed air) to be fed for tire filling via the valve, and the tire pressure measurement device. Because of this a situation can be avoided in which fluids supplied under pressure directly act on the tire pressure measurement device, which can lead to damage or incorrect measurements during the fluid feed.

The power supply can include a battery.

The tire pressure measurement device can include a circuit board or chip with a control device. The circuit board or chip can include a pressure sensor integrated as a component.

The pressure sensor can be designed as a separate component, which is arranged directly on the circuit board or chip.

The tire pressure measurement device can have a communication unit for wireless transmission of pressure measurement signals. The communication unit can also be designed for bidirectional communication.

The communication unit can be designed as a separate component arranged, for example, on the circuit board or chip. The communication unit can be integrated as a component of the circuit board or provided to the chip.

The communication unit can have a protruding, preferably elastically deformable antenna. In the assembled state the antenna can contact a conducting area of the valve via which signals can be transmitted outward. This contact can be achieved or improved, if an elastically deformable antenna in the assembled state is deformed or biased by contact with the valve. Contact can be achieved and/or supported by gluing, soldering or casting. However, contact is not absolutely essential. A limited distance between the antenna and conducting areas of the valve can be sufficient in order to transmit signals outward in the installed state.

In the assembled state the antenna can extend into the first fastening area, preferably beyond it.

The above comments apply for the fastening element mentioned in the introduction, the valve mentioned in the introduction, the tire pressure measurement device mentioned in the introduction, the combination of tire pressure measurement device and fastening element mentioned in the introduction

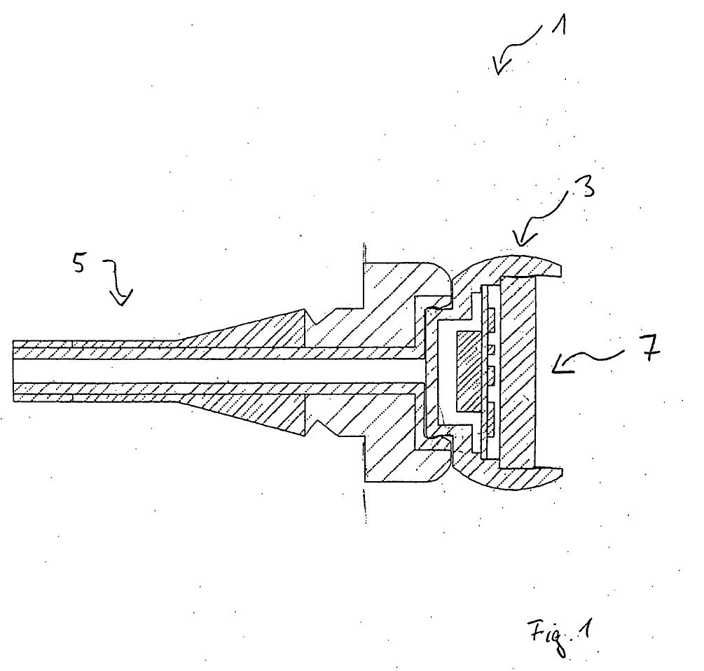

FIG. 1 shows a schematic sectional view of the tire pressure measurement unit 1 according to the invention in the assembled state. The vehicle tire pressure measurement unit 1 includes a fastening element 3, which accommodates a tire pressure measurement device 7 and is connected to a valve 5 via a snap connection. The valve is shown as a snap-in valve for clarification.

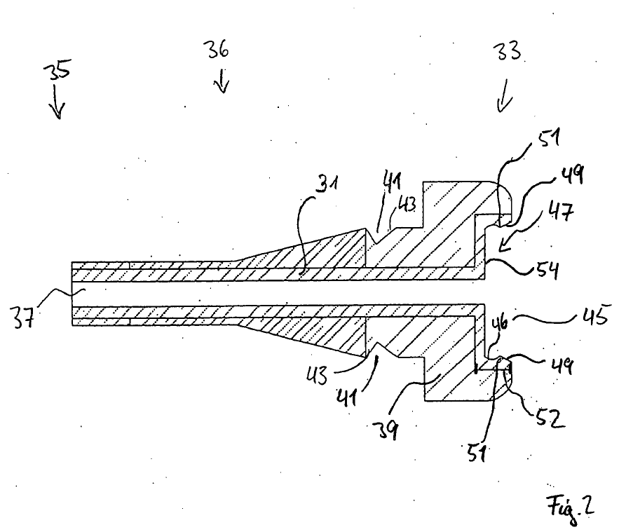

FIG. 2 shows a cross-sectional view of valve 5. The valve 5 has a valve shaft 36, which together with a valve head 35 and a valve foot 33 forms a main body 31. This consists of a solid material, say, metal (for example, brass). Thread can be provided on the upper end of the main body 31 on valve head 35, onto which a valve cap can be screwed (neither is depicted). The valve head 35 is normally situated outside the vehicle tire (not depicted).

The valve 5 also includes a shell 39, which has a groove 41 and borders the valve foot 33 on its lower end. The valve foot 33 is normally situated within a vehicle tire rim (not depicted). The groove 41 in the mounted state of the valve 5 accommodates one edge of valve hole (not depicted) of the vehicle tire rim (not depicted). The shell 39 consists of an elastically deformable material, for example, rubber or plastic. During installation of valve 5 it can therefore be deformed or compressed so that the valve 5 can be pushed through a valve hole (not depicted). After emerging from the valve hole the elastic shell 39 is decompressed or deformed so that it ensures firm and tight seating of the valve in the valve hole. Bulge-like, reinforced areas 43 above or below groove 41 are arranged for this purpose, which support snapping in of the valve.

The main body 31 also extends into the valve foot 33. A receptacle 47 is situated in the valve foot 43. The receptacle 47 forms a second fastening area 45 having a continuous guide surface 49 on its side. The guide surface 49 runs conically. Adjacent to the guide surface 49 there is a snap point 51. In addition, a recess is connected, which abuts the support surface 54.

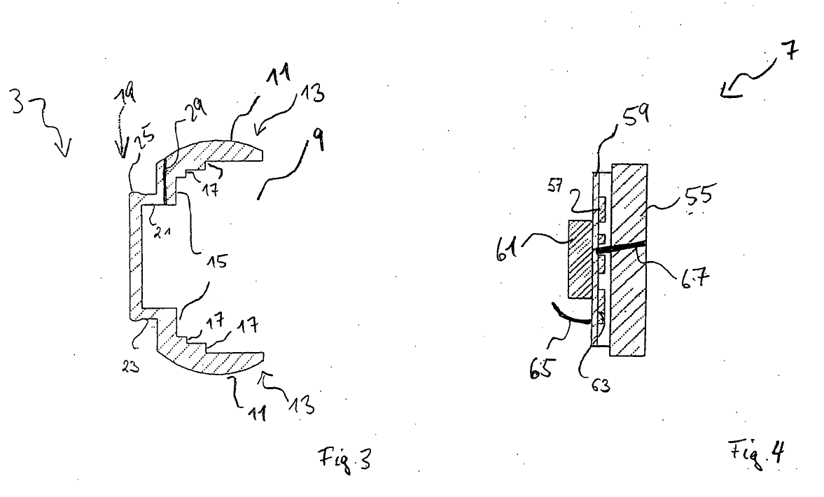

The receptacle area 47 of valve 5 is laid out with the second fastening area 45 in this practical example to accommodate a fastening element 3, as depicted in FIG. 1. Mounting of the fastening element 3 in the receptacle 47 of valve 5 is then possible without special tools. The fastening element 3 is pushed into the valve 5. For this purpose a force sufficient to snap the valve 5 into the second fastening area 45 acts on the fastening element 3 (cf. also FIGS. 1 and 3).

FIG. 3 shows a cross-sectional view of the fastening element 3. The fastening element 3 includes a symmetric, cylindrical, rounded housing made of plastic. It includes side walls 11 which border a receptacle 9 extending in between on the side. The side walls 11 include a thermally deformable area 13. Four protrusions 17 are arranged within the receptacle 9, which abut an inner support surface 15. Adjacent to the inner support surface 15 an additional support area 21 is arranged. A fluid passage opening 29 extends in between transverse to the fastening element 3. On the outside of fastening element 3 adjacent to support area 21, an at least partially elastic area 23 extends as a first fastening area 19 with essentially rigid protruding retainers 25 and elastic segments 27.

The initial support surface 15 as well as the depicted protrusions or stops 17 serve for positioning of the tire pressure measurement device 7 during introduction into the fastening element 3 and for securing in the assembled state. The tire pressure measurement device 7 is then accommodated fully within the fastening element 3. The stop 17 permits exact contact within receptacle 9. The tire pressure measurement device 7 then lies on the inner support surface 15 and is supported against the stops 17.

During deformation of the thermally deformable edge area 13, for example, by UV radiation, the edge area 13 can engage behind the tire pressure of measurement device 7 on its end. Force-fitting and/or shape-mating can therefore be achieved so that the tire pressure measurement device 7 remains firmly in the desired position within the receptacle 9 of fastening element 3.

When the first fastening area 19 is introduced into the second fastening area 45 (cf. also FIGS. 1 and 2) the snap area 23 slides along the guide surfaces 49 in receptacle 47. The snap area 23 is then easily moved inward by the guide surfaces 49 until it has reached the snap point 51. The degree of deformation of snap area 23 is highest here. The snap point is overcome when an additional force acts in the fastening element 3 in the direction of valve 5. The snap area 23 assumes essentially its original shape. When forces act vertically in the longitudinal direction, forces act on the two peripherally protruding retainers 25. These sit firmly in the recesses and divert the force into the valve foot. It is therefore not possible to remove the fastening element 5 vertically downward from the snap connection and therefore from valve 5 and the second fastening area 45 there.

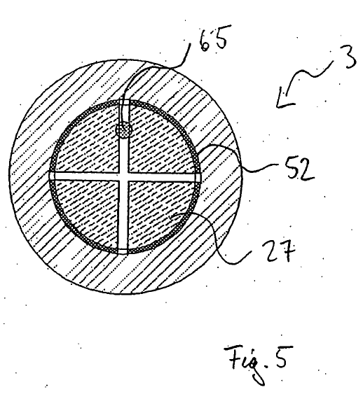

FIG. 4 shows a cross-sectional view of the tire pressure measurement device 7. The tire pressure measurement device 7 includes a pressure sensor 57 with a power supply 55, which can be a battery 55, a circuit board 59, a control device 61 and a communication unit 63. The control device 61 is arranged on circuit board 59 on which electronics for transmission (for example, wireless) of data are present. The communication unit 63 is connected to the circuit board and has a protruding antenna 65. The battery 55 is connected to circuit board 59 by soldering tab 67 for firm connection. The control device 61, as well as the pressure sensor 57, which is arranged according to the depiction on circuit board 59, can also be integrated as components in circuit board 59. The battery 55 according to the depiction serves as cover for the additional components of the tire pressure measurement device 7 and also as a cover or closure of the receptacle 9 on its right open end according to the depiction. A fluid-tight closure relative to the tire interior can be achieved on this account.

The tire pressure measurement device 7 can be arranged in variants not shown so that the power supply 55 lies between the left end of receptacle 9 adjacent to valve 5 and the additional components of the tire pressure measurement device 7. This avoids a situation in which fluids supplied under pressure via valve 5 act directly on the tire pressure measurement device, especially its electrical, electronic and/or sensor components, and in so doing cause damage or malfunction.

The antenna 65 extends into the first fastening area 19 of fastening element 3 (cf. FIG. 5) and emerges through an opening in the snap area 23 in the direction of valve 5 between the elastic snap segment 27 (see also FIG. 5).

In the assembled state, because of the proximity to main body 31 of valve 5, contact is made possible between antenna 65 and main body 31. Since the main body 31 consists of a metal, for example, brass, this acts as an antenna, via which pressure measurement singles can be received from the communication unit 63 or antenna 65 and conveyed to an external receiving unit (not depicted). Signals that indicate air pressure of the vehicle tire and/or air pressure deviations from target values, etc. can then be transmitted.

If the tire pressure measurement device 7 is arranged within the fastening element 5, the pressure sensor 57 is situated in receptacle 9. In the assembled state of the vehicle tire pressure measurement unit 1 (cf. FIG. 1) a fluid connection exists via a fluid feed channel 37 of valve 5 which discharges into the second fastening area 45 with the area of receptacle 9 of fastening element 3 and the tire pressure measurement device 7 extending in the first fastening area 19. Fluid, especially gas provided for tire filling, can flow to the fluid passage openings 29 and through them outward. In the installed state a tire can be filled in this way with gas. Fluid flow in the opposite direction removes gas from the tire.

The snap connection can be essentially fluid-tight so that only slight amounts of fluid can emerge at the boundary areas between the fastening areas 19 and 45, if at all. Fluid tightness can also be produced by the design of the snap connection and/or sealing elements (not shown). However, tightness can be dispensed with, if fluid cannot escape in undesired fashion from a vehicle tire.

As is apparent from FIG. 5, fluid can flow through intermediate spaces (not shown) between the elastically deformable segments 27. The fluid can then be both air as well as another gas, like nitrogen or another liquid gas mixture, as is known for foam filling of a tire.

After filling of the vehicle tire, the tire internal pressure lies on the pressure sensor 57 above the fluid passage opening 29.

FIG. 5 shows a view of the fastening element 3. Here a division of the snap area 23 into four symmetrically arranged equally large deformable elastic segments 27 is depicted. Antenna 65 is also shown.

When the first fastening area 19 is snapped into the second fastening area 45 of the valve 5 the four elastically deformable segments 27 are deformed inward in the direction of their common center point to the snap point 51, whereupon they snap into groove 46 (cf. FIGS. 1 to 4).

Viewed overall, the total weight in an embodiment of the vehicle tire pressure measurement unit according to the invention can be advantageously reduced significantly, for example, to 8.5 to 9 g, assembly and installation can be simplified and accelerated and the total height reduced by 4 to 5 mm. The manufacturing process is also advantageously accelerated and therefore the production costs reduced. A vehicle tire pressure measurement unit according to the invention can be used in all type of tire rims, for example, steel or aluminum rims.

### LIST OF REFERENCE NUMBERS

1 Vehicle tire pressure measurement unit
3 Fastening element
5 Valve
7 Tire pressure measurement device
3 Fastening element:
9 Receptacle
11 Side wall
13 Thermally deformable area
15 Inner support area
17 Stop
19 First fastening area
21 Support area
23 At least partially elastically deformable area
25 Retainer
27 Elastic segment
29 Fluid passage opening
5 Valve:
31 Main body
33 Valve foot
35 Valve head
36 Valve shaft
37 Channel
39 Shell
41 Grove
43 Bulge
45 Second fastening area
46 Recess/groove
47 Receptacle
49 Guide surface
51 Snap point
52 Snap area
54 Support surface
7 Tire pressure measurement device:
55 Power supply/battery
57 Pressure sensor
59 Circuit board
61 Control device
63 Communication unit
65 Antenna
66 Soldering connection

1. Vehicle tire pressure measurement unit comprising
a valve, and
a fastening element for arrangement of a tire pressure measurement device on the valve, in which
the fastening element can include a first fastening area for snap connection with a second fastening area formed in complementary fashion on the valve to secure the fastening element and the valve to each other, and
the fastening element includes a receptacle for arrangement of the tire pressure measurement device in the fastening element, in which the receptacle of the fastening element includes an area that extends into the first fastening area.

2. Vehicle tire pressure measurement unit according to claim 1, in which at least the area of the receptacle of the fastening element that extends into the first fastening area is designed as a fluid guide.

3. Vehicle tire pressure measurement unit according to claim 1, in which the receptacle of the fastening element includes at least one thermally deformable area.

4. Vehicle tire pressure measurement unit according to claim 1, in which the first fastening area can be snapped into the second fastening area or in which the second fastening area can be snapped into the first fastening area.

5. Vehicle tire pressure measurement unit according to claim 1, in which the first fastening area includes at least one at least partially elastic area for the snap connection or in which the second fastening area includes at least one at least partially elastic area for the snap connection.

6. Vehicle tire pressure measurement unit according to claim 1, in which the fastening element includes at least one fluid passage opening.

7. Vehicle tire pressure measurement unit according to claim 1, including the tire pressure measurement device, in which the tire pressure measurement device is arranged by means of the fastening element and the tire pressure measurement device includes a power supply, pressure sensor and a circuit board or chip with a control device.

8. Vehicle tire pressure measurement unit according to claim 1, in which the tire pressure measurement device includes a communication unit for wireless transmission of pressure measurement signals.

9. Vehicle tire pressure measurement unit according to claim 8, in which the communication unit includes a protruding, elastically deformable antenna.

10. Vehicle tire pressure measurement unit according to claim 9, in which the antenna in the assembled state contacts a conducting area of the valve.

11. Vehicle tire pressure measurement unit according to claim 9, in which the antenna in the assembled state extends into the first fastening area.

12. Fastening element for arrangement of a tire pressure measurement device on a valve in a vehicle tire pressure measurement unit comprising
a first fastening area for snap connection with a second fastening area formed in complementary fashion on the valve to secure the fastening element in the valve to each other,
in which the fastening element includes a receptacle for arrangement of the tire pressure measurement device in the fastening element, and
in which the receptacle of the fastening element includes an area that extends into the first fastening area.

13. Valve for a vehicle tire pressure measurement unit, which includes a fastening element for arrangement of a tire pressure measurement device on the valve, with a fastening area for snap connection with a fastening area made in complementary fashion on the fastening element of the vehicle tire pressure measurement unit, to secure the fastening element and the valve to each other.

14. (canceled)
